(19) United States
(12) Patent Application Publication
(10) Pub. No.: US 2017/0308289 A1
(43) Pub. Date: Oct. 26, 2017

(54) ICONOGRAPHIC SYMBOL SEARCH WITHIN A GRAPHICAL KEYBOARD

(71) Applicant: Google Inc., Mountain View, CA (US)

(72) Inventor: Dong Ho Kim, Palo Alto, CA (US)

(21) Appl. No.: 15/133,282

(22) Filed: Apr. 20, 2016

(51) Int. Cl. G06F 3/0488; G06F 3/0484; G06F 3/0482; G06F 3/0481

(52) U.S. Cl. CPC G06F 3/04886; G06F 3/04883; G06F 3/04817; G06F 3/0482; G06F 3/04842

(57) ABSTRACT

A computing device is described that displays a graphical keyboard including an iconographic search key associated with an iconographic search function of the graphical keyboard and responsive to a selection of the iconographic search key, displays a first updated graphical keyboard that includes an iconographic search box configured to display indications of search queries associated with the iconographic search function. The computing device determines, based on user input, an iconographic search query, and displays, within the iconographic search box, a graphical indication of the iconographic search query. The device identifies, based on the iconographic search query and using the iconographic search function of the graphical keyboard, candidate iconographic symbols and displays, a second updated graphical keyboard that includes, an iconographic suggestion region displaying one or more selectable elements corresponding to the candidate iconographic symbols.

### BACKGROUND

Despite being able to simultaneously execute several applications, some mobile computing devices can only present a graphical user interface (GUI) of a single application, at a time. To interact with multiple applications at once, a user of a mobile computing device may have to switch between different application GUIs. For example, a user of a mobile computing device may have to cease entering text in a messaging application and provide input to cause the device to toggle to a search application to search for a particular piece of information (e.g., an iconographic symbol such as an emoji symbol) to use when composing a message or otherwise entering text.

### SUMMARY

In one example, a method includes outputting, by a computing device, for display, a graphical keyboard comprising a plurality of keys, wherein the plurality of keys includes an iconographic search key associated with an iconographic search function of the graphical keyboard, responsive to receiving an indication of a selection of the iconographic search key, outputting, by the computing device, for display, a first updated graphical keyboard that includes, in addition to the plurality of keys, an iconographic search box configured to display indications of search queries associated with the iconographic search function, and determining, by the computing device, based on user input, an iconographic search query. The method further includes outputting, by the computing device, for display within the iconographic search box, a graphical indication of the iconographic search query, identifying, by the computing device, based on the iconographic search query and using the iconographic search function of the graphical keyboard, one or more candidate iconographic symbols, and responsive to identifying the one or more candidate iconographic symbols, outputting, by the computing device, for display, a second updated graphical keyboard that includes, in addition to at least a portion of the plurality of keys, an iconographic suggestion region displaying one or more selectable elements corresponding to the one or more candidate iconographic symbols.

In another example, a computing device includes a presence-sensitive display, at least one processor, and a memory that stores instructions. The instructions, when executed by the at least one processor, cause the at least one processor to output, for display at the presence-sensitive display, a graphical keyboard comprising a plurality of keys, wherein the plurality of keys includes an iconographic search key associated with an iconographic search function of the graphical keyboard, and responsive to receiving an indication of a selection of the iconographic search key detected at the presence-sensitive display, output, for display at the presence-sensitive display, a first updated graphical keyboard that includes, in addition to the plurality of keys, an iconographic search box configured to display indications of search queries associated with the iconographic search function. The instructions, when executed, further cause the at least one processor to determine, based on user input, an iconographic search query, output, for display at the presence-sensitive display, within the iconographic search box, a graphical indication of the iconographic search query, identify, based on the iconographic search query and using the iconographic search function of the graphical keyboard, one or more candidate iconographic symbols, and responsive to identifying the one or more candidate iconographic symbols, output, for display at the presence-sensitive display, a second updated graphical keyboard that includes, in addition to at least a portion of the plurality of keys, an iconographic suggestion region displaying one or more selectable elements corresponding to the one or more candidate iconographic symbols.

In another example, computer-readable storage medium is encoded with instructions that, when executed by at least one processor of a computing device, cause the at least one processor to output, for display, a graphical keyboard comprising a plurality of keys, wherein the plurality of keys includes an iconographic search key associated with an iconographic search function of the graphical keyboard, responsive to receiving an indication of a selection of the iconographic search key, output, for display, a first updated graphical keyboard that includes, in addition to the plurality of keys, an iconographic search box configured to display indications of search queries associated with the iconographic search function, and determine, based on user input, an iconographic search query. The instructions, when executed, further cause the at least one processor to output, for display within the iconographic search box, a graphical indication of the iconographic search query, identify, based on the iconographic search query and using the iconographic search function of the graphical keyboard, one or more candidate iconographic symbols, and responsive to identifying the one or more candidate iconographic symbols, output, for display, a second updated graphical keyboard that includes, in addition to at least a portion of the plurality of keys, an iconographic suggestion region displaying one or more selectable elements corresponding to the one or more candidate iconographic symbols.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIGS. 1A-1D are conceptual diagrams illustrating an example computing device that is configured to present a graphical keyboard with integrated iconographic search, in accordance with one or more aspects of the present disclosure.

FIG. 2 is a block diagram illustrating an example computing device that is configured to present a graphical keyboard with integrated iconographic search, in accordance with one or more aspects of the present disclosure.

FIG. 3 is a block diagram illustrating an example computing device that outputs graphical content for display at a remote device, in accordance with one or more techniques of the present disclosure.

FIGS. 4A-4F are conceptual diagrams illustrating example graphical user interfaces of an example computing device that is configured to present a graphical keyboard with integrated iconographic search, in accordance with one or more aspects of the present disclosure.

FIG. 5 is a flowchart illustrating example operations of a computing device that is configured to present a graphical keyboard with integrated iconographic search, in accordance with one or more aspects of the present disclosure.

### DETAILED DESCRIPTION

In general, this disclosure is directed to techniques for enabling a computing device to conduct an iconographic symbol search from within an iconographic search region of a graphical keyboard. For example, as a computing device detects input at a graphical keyboard of a graphical user interface (GUI) of a messaging application, the computing device may receive an indication of a selection of an iconographic search key and, in response to the selection, the computing device may display, within the graphical keyboard, an iconographic search box. Based on input later detected at the graphical keyboard, the computing device may determine an iconographic search query (e.g., a typed text, handwritten, or hand drawn query for an emoji symbol) from which the computing device may identify one or more candidate iconographic symbols. The computing device may display the candidate iconographic symbols within an iconographic suggestion region of the graphical keyboard and a user may select one or more of the candidate iconographic symbols to be used as content for an electronic message.

By providing a graphical keyboard with built-in iconographic symbol search capability, a user of an example computing device may quickly search for and obtain selectable iconographic symbols from within the graphical keyboard at which the user is already typing, rather than requiring the user to wade through many pages of categorized iconographic symbols or switch between different application GUIs to look-up a particular iconographic symbol. In this way, techniques of this disclosure may reduce the amount of time and the number of user inputs required by a computing device to find a particular iconographic symbol, which may simplify the user experience and may reduce power consumption of a computing device.

As used herein, the term “iconographic symbol” is used to generally refer to various types of “emoji” characters, emoji phrases, emoji symbols, and all other types of (typically non-textual) emoticons, icons, characters, and special symbols, whether part of the ASCII or Unicode standards. As used herein, iconographic symbols are distinct from, and should not be construed as being ideographic symbols, such as Chinese characters and Roman numerals. For ease of description, the following techniques are described primarily from the perspective of emoji symbols. However, these techniques may be used with any type of iconographic symbol.

Throughout the disclosure, examples are described where a computing device and/or a computing system analyzes information (e.g., context, locations, speeds, search queries, etc.) associated with a computing device and a user of a computing device, only if the computing device receives permission from the user of the computing device to analyze the information. For example, in situations discussed below, before a computing device or computing system can collect or may make use of information associated with a user, the user may be provided with an opportunity to provide input to control whether programs or features of the computing device and/or computing system can collect and make use of user information (e.g., information about a user's current location, current speed, etc.), or to dictate whether and/or how to the device and/or system may receive content that may be relevant to the user. In addition, certain data may be treated in one or more ways before it is stored or used by the computing device and/or computing system, so that personally-identifiable information is removed. For example, a user's identity may be treated so that no personally identifiable information can be determined about the user, or a user's geographic location may be generalized where location information is obtained (such as to a city, ZIP code, or state level), so that a particular location of a user cannot be determined. Thus, the user may have control over how information is collected about the user and used by the computing device and computing system.

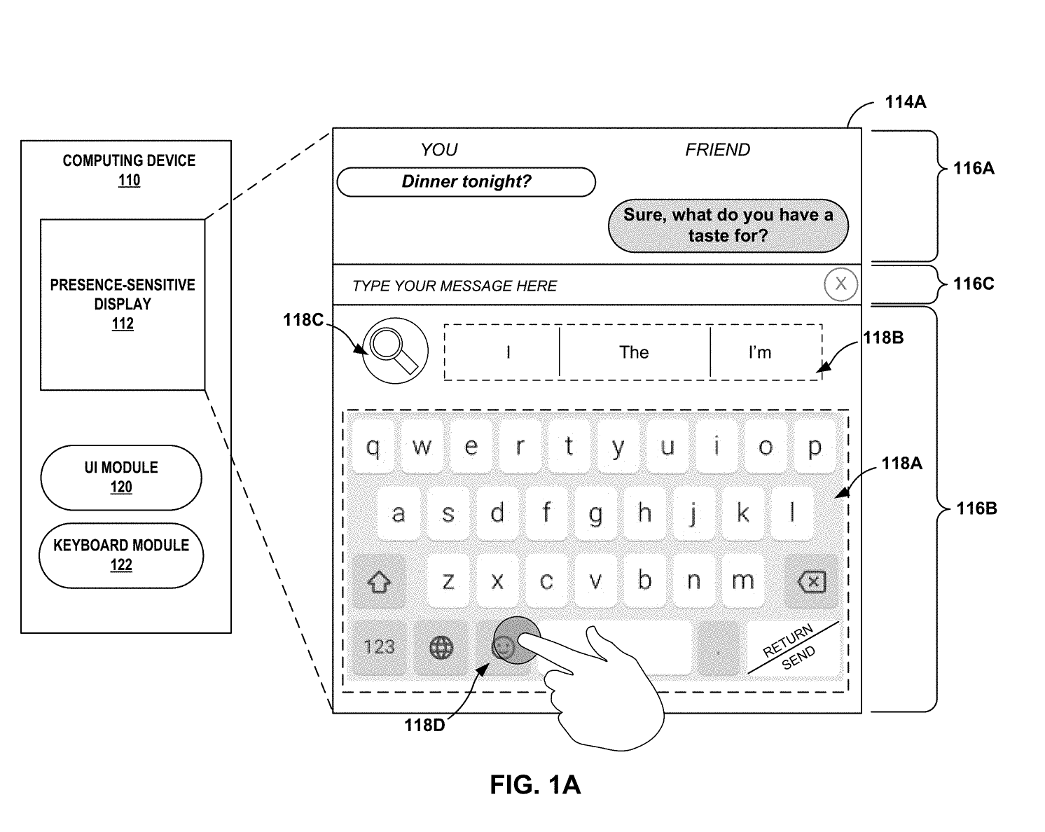

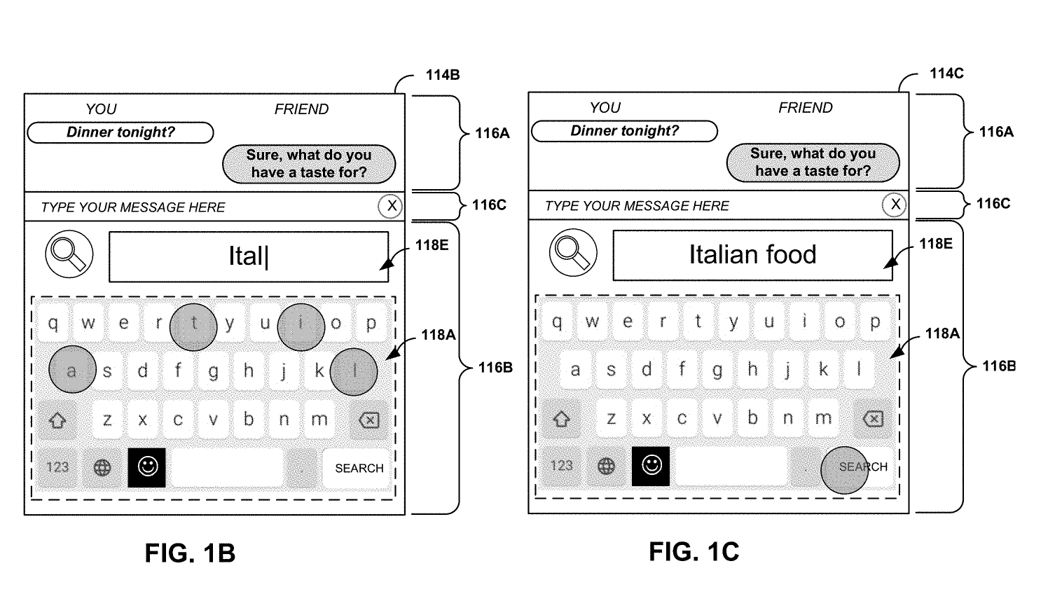

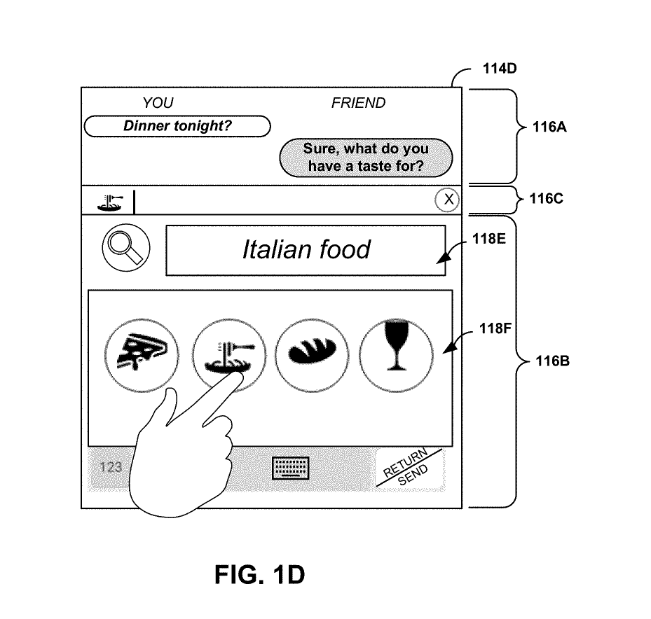

FIGS. 1A-1D are conceptual diagrams illustrating an example computing device 110 that is configured to present a graphical keyboard with integrated iconographic search, in accordance with one or more aspects of the present disclosure. Computing device 110 may represent a mobile device, such as a smart phone, a tablet computer, a laptop computer, computerized watch, computerized eyewear, computerized gloves, or any other type of portable computing device. Additional examples of computing device 110 include desktop computers, televisions, personal digital assistants (PDA), portable gaming systems, media players, e-book readers, mobile television platforms, automobile navigation and entertainment systems, vehicle (e.g., automobile, aircraft, or other vehicle) cockpit displays, or any other types of wearable and non-wearable, mobile or non-mobile computing devices that may output a graphical keyboard for display.

Computing device 110 includes a presence-sensitive display (PSD) 112, user interface (UI) module 120 and keyboard module 122. Modules 120 and 122 may perform operations described using software, hardware, firmware, or a mixture of hardware, software, and firmware residing in and/or executing at computing device 110. One or more processors of computing device 110 may execute instructions that are stored at a memory or other non-transitory storage medium of computing device 110 to perform the operations of modules 120 and 122. Computing device 110 may execute modules 120 and 122 as virtual machines executing on underlying hardware. Modules 120 and 122 may execute as one or more services of an operating system or computing platform. Modules 120 and 122 may execute as one or more executable programs at an application layer of a computing platform.

PSD 112 of computing device 110 may function as respective input and/or output devices for computing device 110. PSD 112 may be implemented using various technologies. For instance, PSD 112 may function as input devices using presence-sensitive input screens, such as resistive touchscreens, surface acoustic wave touchscreens, capacitive touchscreens, projective capacitance touchscreens, pressure sensitive screens, acoustic pulse recognition touchscreens, or another presence-sensitive display technology. PSD 112 may also function as output (e.g., display) devices using any one or more display devices, such as liquid crystal displays (LCD), dot matrix displays, light emitting diode (LED) displays, organic light-emitting diode (OLED) displays, e-ink, or similar monochrome or color displays capable of outputting visible information to a user of computing device 110.

PSD 112 may detect input (e.g., touch and non-touch input) from a user of respective computing device 110. PSD 112 may detect indications of input by detecting one or more gestures from a user (e.g., the user touching, pointing, and/or swiping at or near one or more locations of PSD 112 with a finger or a stylus pen). PSD 112 may output information to a user in the form of a user interface (e.g., user interfaces 114A-114D), which may be associated with functionality provided by computing device 110. Such user interfaces may be associated with computing platforms, operating systems, applications, and/or services executing at or accessible from computing device 110 (e.g., electronic message applications, chat applications, Internet browser applications, mobile or desktop operating systems, social media applications, electronic games, and other types of applications). For example, PSD 112 may present user interfaces 114A-114D (collectively referred to as “user interfaces 114”) which, as shown in FIGS. 1A-1D, are graphical user interfaces of a chat application executing at computing device 110 and includes various graphical elements displayed at various locations of PSD 112.

As shown in FIGS. 1A-1C, user interfaces 114 are part of a chat user interface, however user interfaces 114 may be any graphical user interface which includes a graphical keyboard with integrated search features. User interfaces 114 include output region 116A, graphical keyboard 116B, and edit region 116C. A user of computing device 110 may provide input at graphical keyboard 116B to produce textual characters and/or emoji symbols within edit region 116C that form the content of the electronic messages displayed within output region 116A. The messages displayed within output region 116A form a chat conversation between a user of computing device 110 and a user of a different computing device.

UI module 120 manages user interactions with PSD 112 and other components of computing device 110. In other words, UI module 120 may act as an intermediary between various components of computing device 110 to make determinations based on user input detected by PSD 112 and generate output at PSD 112 in response to the user input. UI module 120 may receive instructions from an application, service, platform, or other module of computing device 110 to cause PSD 112 to output a user interface (e.g., user interfaces 114). UI module 120 may manage inputs received by computing device 110 as a user views and interacts with the user interface presented at PSD 112 and update the user interface in response to receiving additional instructions from the application, service, platform, or other module of computing device 110 that is processing the user input.

Keyboard module 122 represents an application, service, or component executing at or accessible to computing device 110 that provides computing device 110 with a graphical keyboard having integrated search capability. Keyboard module 122 may switch between operating in text-entry mode in which keyboard module 122 functions similar to a traditional graphical keyboard, or search mode in which keyboard module 122 performs various integrated search functions, such as emoji symbol search.

In some examples, keyboard module 122 may be a stand-alone application, service, or module executing at computing device 110 and in other examples, keyboard module 122 may be a sub-component thereof. For example, keyboard module 122 may be integrated into a chat or messaging application executing at computing device 110 whereas in other examples, keyboard module 122 may be a stand-alone application or subroutine that is invoked by an application or operating platform of computing device 110 any time an application or operating platform requires graphical keyboard input functionality. In some examples, computing device 110 may download and install keyboard module 122 from an application repository of a service provider (e.g., via the Internet). In other examples, keyboard module 122 may be preloaded during production of computing device 110.

When operating in text-entry mode, keyboard module 122 of computing device 110 may perform traditional, graphical keyboard operations used for text-entry, such as: generating a graphical keyboard layout for display at PSD 112, mapping detected inputs at PSD 112 to selections of graphical keys, determining characters based on selected keys, or predicting or autocorrecting words and/or phrases based on the characters determined from selected keys.

Graphical keyboard 116B includes graphical elements displayed as graphical keys 118A. Graphical keys 118A include emoji search key 118D as an example iconographic search key. Keyboard module 122 may output information to UI module 120 that specifies the layout of graphical keyboard 116B within user interfaces 114. For example, the information may include instructions that specify locations, sizes, colors, and other characteristics of graphical keys 118A. Based on the information received from keyboard module 122, UI module 120 may cause PSD 112 display graphical keyboard 116B as part of user interfaces 114.

Some of keys 118A may be associated with individual characters (e.g., a letter, number, punctuation, or other character) that are displayed within the key. A user of computing device 110 may provide input at locations of PSD 112 at which one or more of graphical keys 118A are displayed to input content (e.g., characters, search results, etc.) into edit region 116C (e.g., for composing messages that are sent and displayed within output region 116A or for inputting a search query that computing device 110 executes from within graphical keyboard 116B). Keyboard module 122 may receive information from UI module 120 indicating locations associated with input detected by PSD 112 that are relative to the locations of each of the graphical keys. Using a spatial and/or language model, keyboard module 122 may translate the inputs to selections of keys and characters, words, phrases, emoji symbols, emoji phrases, or other iconographic symbols and phrases.

For example, PSD 112 may detect user inputs as a user of computing device 110 provides user inputs at or near a location of PSD 112 where PSD 112 presents graphical keys 118A. UI module 120 may receive, from PSD 112, an indication of the user input at PSD 112 and output, to keyboard module 122, information about the user input. Information about the user input may include an indication of one or more touch events (e.g., locations and other information about the input) detected by PSD 112.

Based on the information received form UI module 120, keyboard module 122 may map detected inputs at PSD 112 to selections of graphical keys 118A, determine characters based on selected keys 118A, and predict or autocorrect words and/or phrases determined based on the characters associated with the selected keys 118A. For example, keyboard module 122 may include a spatial model that may determine, based on the locations of keys 118A and the information about the input, the most likely one or more keys 118A being selected. Responsive to determining the most likely one or more keys 118A being selected, keyboard module 122 may determine one or more characters, words, and/or phrases. For example, each of the one or more keys 118A being selected from a user input at PSD 112 may represent an individual character or a keyboard operation. Keyboard module 122 may determine a sequence of characters selected based on the one or more selected keys 118A. In some examples, keyboard module 122 may apply a language model to the sequence of characters to determine one or more the most likely candidate letters, morphemes, words, and/or phrases that a user is trying to input based on the selection of keys 118A

Keyboard module 122 may send the sequence of characters and/or candidate words and phrases to UI module 120 and UI module 120 may cause PSD 112 to present the characters and/or candidate words determined from a selection of one or more keys 118A as text within edit region 116C. In some examples, when functioning as a traditional keyboard for performing text-entry operations, and in response to receiving a user input at graphical keys 118A (e.g., as a user is typing at graphical keyboard 116B to enter text within edit region 116C), keyboard module 122 may cause UI module 120 to display the candidate words, etc. as one or more selectable suggestions within suggestion region 118B. A user can select an individual suggestion within suggestion region 118B rather than type all the individual character keys of graphical keys 118A.

In addition to performing traditional text-entry operations, keyboard module 122 of computing device 110 also provides integrated search capability. That is, rather than requiring a user of computing device 110 to navigate away (e.g., to a different application or service executing at or accessible from computing device 110) from user interfaces 114 where graphical keyboard 116B is displayed, keyboard module 122 may operate in search mode in which keyboard module 122 may execute search operations and present search results within the same region of PSD 112 at which graphical keyboard 116B is displayed.

As indicated above, keyboard module 122 may execute as a stand-alone application, service, or module executing at computing device 110 or as a single, integrated sub-component thereof. Therefore, if keyboard module 122 forms part of a chat or messaging application executing at computing device 110, keyboard module 122 may provide the chat or messaging application with text-entry capability as well as search capability. Similarly, if keyboard module 122 is a stand-alone application or subroutine that is invoked by an application or operating platform of computing device 110 any time an application or operating platform requires graphical keyboard input functionality, keyboard module 122 may provide the invoking application or operating platform with text-entry capability as well as search capability.

Keyboard module 122 may cause graphical keyboard 116B to include search element 118C. Search element 118C represents a selectable element of graphical keyboard 116B for causing keyboard module 122 to transition to manually invoke one or more of the various search features of graphical keyboard 116B. By selecting search element 118C (e.g., by tapping or gesturing at a location or within a region of PSD 112 at which search element 118C is displayed), a user can cause computing device 110 to operate in search mode and perform a search function without having to navigate to a separate application, service, or other feature executing at or accessible from computing device 110.

For example, UI module 120 may output information to keyboard module 122 indicating that a user of computing device 110 may have selected selectable element 118C. Responsive to determining that element 118C was selected, keyboard module 122 may transition to operating in search mode. While operating in search mode, keyboard module 122 may reconfigure graphical keyboard 116B to execute a search function, such as presenting suggested search content (e.g., predicted search queries, predicted iconographic symbols, emoticons, emoji symbols and phrases, or other suggested content) as selectable elements within suggestion region 118B instead of or in addition to suggested words or other primarily linguistic information that keyboard module 122 derives from a language model, lexicon, or dictionary. In other words, rather than just providing spelling or word suggestions from a dictionary within suggestion region 118B, computing device 110 may include, within suggestion region 118B, suggested search related content that computing device 110 determines may assist a user in providing input related to an electronic communication.

Graphical keys 118A include emoji search key 118D as an example iconographic search key. Emoji search key 118D represents a selectable element of graphical keyboard 116B for manually invoking an emoji search function of graphical keyboard 116B as an example iconographic search function. By selecting emoji search key 118D (e.g., by tapping or gesturing at a location or within a region of PSD 112 at which emoji search key 118D is displayed), a user can cause computing device 110 to transition to search mode and execute an emoji search function of graphical keyboard 116B without having to navigate to a separate application, service, or other feature executing at or accessible from computing device 110.

For example, UI module 120 may output information to keyboard module 122 indicating that a user of computing device 110 may have provided a tap or gesture input at a location of PSD 112 at which emoji search key 118D is displayed. Keyboard module 122 may induce from the information received from UI module 120 that a user selected emoji search key 118D. As shown in FIG. 1A, responsive to determining that emoji search key 118D was selected, keyboard module 122 may transition to operating in search mode and execute an emoji search function whereby keyboard module 122 may reconfigure graphical keyboard 116B to receive input associated with emoji search queries and display, from within graphical keyboard 116B, emoji search results.

As shown in FIG. 1B, responsive to receiving an indication of a selection of emoji search key 118D, keyboard module 122 may cause computing device 110 to output for display, user interface 114B. User interface 114B includes an updated graphical keyboard 116B that includes, in addition to keys 118A, emoji search box 118E as an example iconographic search box. Emoji search box 118E is configured to display indications of search queries associated with the emoji search function of keyboard module 122. A user may provide user input at graphical keyboard 116B and keyboard module 122 may present an emoji search query derived from the user input at emoji search box 118E.

For example, responsive to detecting a selection of emoji search key 118D, keyboard module 122 may send information to UI module 120 for causing PSD 112 to replace user interface 114A with user interface 114B. After presenting user interface 114B at PSD 112, keyboard module 122 may determine, based on additional user input, an emoji search query. For example, computing device 110 may receive voice input detected by a microphone of computing device 110, gesture input detected by PSD 112 as a user of computing device 110 provides user inputs at or near a location of PSD 112 where PSD 112 presents graphical keys 118A, or some other user input (e.g., handwriting or drawing input at or near a location of PSD 112, etc.). UI module 120 may send information to keyboard module 122 about the user input and from the information, keyboard module 122 may predict an emoji search query that a user is likely trying to enter. For instance, a speech-to-text feature of keyboard module 122 may transcribe voice input to a text-based emoji search query. Or in some examples, keyboard module 122 may rely on the spatial and/or language model of keyboard module 122 to convert touch input detected by PSD 112 at keys 118A to one or more candidate words or phrases that make up an emoji search query. Still in other examples, keyboard module 122 may interpret touch input detected by PSD 112 as a handwritten drawing of an image that makes up an image-based emoji search query.

In any case, after determining the emoji search query based on user input, keyboard module 122 may cause computing device 110 to output, for display within emoji search box 118E, a graphical indication of the emoji search query. As shown in FIG. 1B, keyboard module 122 may detect user input as selections of graphical keys 118A and present the characters “Ital” that keyboard module 122 determines from the selections within emoji search box 118E.

Next, as shown in FIG. 1C, keyboard module 122 may predict, based on the characters derived from the selection, an emoji search query that the user is likely trying to enter and automatically replace the characters “Ital” with the phrase “Italian food”. In other words, rather than requiring the user to input an entire emoji search query manually, by selecting each individual character key 118A, keyboard module 122 may predict (e.g., by performing a real-time lookup in a database of potential emoji search queries) and display an emoji search query that the user is likely typing before the user has finished typing the entire query.

Keyboard module 122 may identify, based on the emoji search query and using the emoji search function of graphical keyboard 116B, one or more candidate emoji symbols. For instance, in some examples, a user may tap or gesture at or near a location at which a search key of keys 118A is displayed to cause keyboard module 122 to execute an emoji search. In other examples, keyboard module 122 may automatically execute (e.g., without requiring selection of the search key) the emoji search while the user is typing or providing user input associated with the query.

Responsive to obtaining the one or more candidate emoji symbols, keyboard module 122 may cause computing device 110 to output, for display, a second updated graphical keyboard that includes, in addition to at least a portion of the plurality of keys 118A, emoji suggestion region 118F displaying one or more selectable elements corresponding to the one or more candidate emoji symbols. For example, as shown in FIG. 1D, keyboard module 122 may execute a search for an emoji symbol by querying the emoji search query at a local emoji symbol data base that keyboard module 122 maintains at computing device 110. Results of the search may include a pizza emoji, a spaghetti or pasta dish emoji, a bread emoji, and a wine emoji, or any other emoji that keyboard module 122 determines to be related to the emoji search query “Italian food”. Keyboard module 122 may cause UI module 120 to present results from the emoji search as graphical indications of candidate emoji symbols within emoji suggestion region 118F. Although shown as replacing at least a portion of graphical keys 118A in FIG. 1D, in some examples, emoji suggestion region 118F may form part of a separate region of graphical keyboard 116B that is displayed, in addition to graphical keys 118A, by computing device 110 at PSD 112. In other words, in some examples, emoji suggestion region 118F may replace all of graphical keys 118A, all but a portion of graphical keys 118A, or none of graphical keys 118A. And in some examples, as described below with respect to the additional FIGS., emoji suggestion region 118F may form part of, or replace, suggestion region 118B.

After outputting candidate emoji symbols within emoji suggestion region 118F, computing device 110 may receive an indication of a selection of at least one of the one or more selectable elements, and may output, for display, within edit region 116C, at least one of the one or more candidate emoji symbols. For example, a user may tap or gesture at a location of PSD 112 at which the pasta dish emoji symbol is displayed within emoji suggestion region 118F and in response, keyboard module 122 may receive an indication of the tap or gesture. Keyboard module 122 may interpret the tap or gesture as a selection of one of the candidate emoji symbols and cause UI module 120 to output the selected emoji symbol for display within edit region 116C.

By providing a graphical keyboard with integrated emoji symbol search, a user of an example computing device, such as computing device 110, may quickly search for and obtain selectable emoji symbols from within a graphical keyboard at which the user is already typing, rather than requiring the user to wade through many pages of categorized emoji symbols or switch between different application GUIs to look-up a particular emoji symbol. In this way, techniques of this disclosure may reduce the amount of time and the number of user inputs required by a computing device to find a particular emoji symbol, which may simplify the user experience and may reduce power consumption of a computing device.

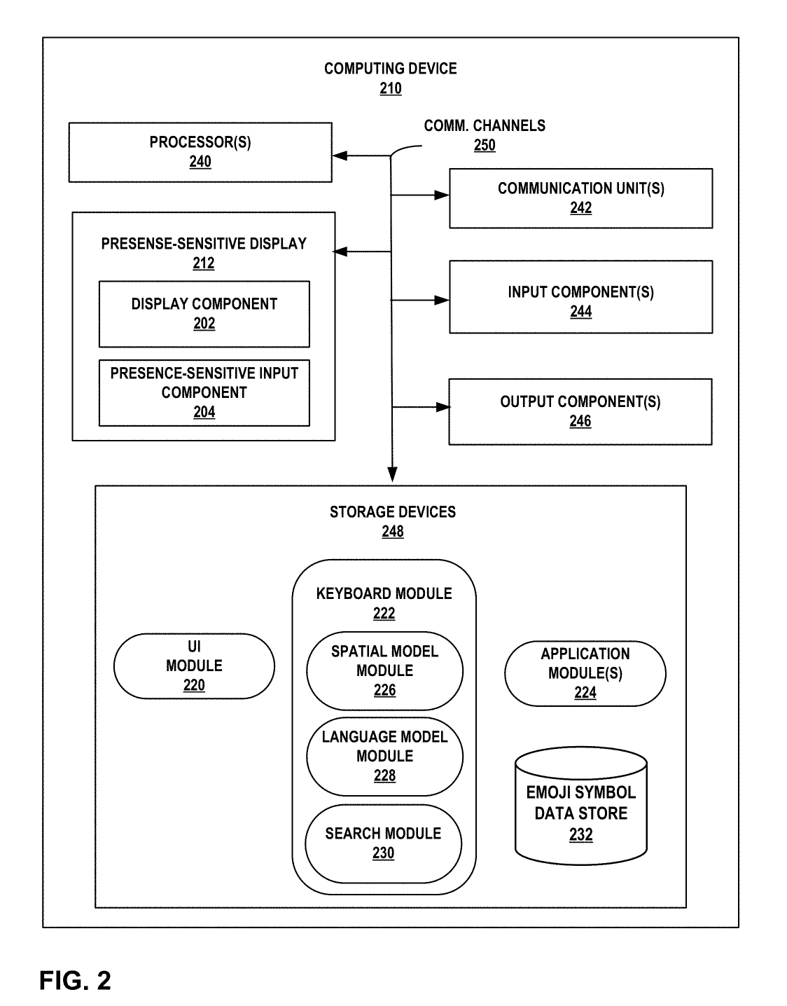

FIG. 2 is a block diagram illustrating computing device 210 as an example computing device that is configured to present a graphical keyboard with integrated iconographic search, in accordance with one or more aspects of the present disclosure. Computing device 210 of FIG. 2 is described below as an example of computing device 110 of FIGS. 1A-1D. FIG. 2 illustrates only one particular example of computing device 210, and many other examples of computing device 210 may be used in other instances and may include a subset of the components included in example computing device 210 or may include additional components not shown in FIG. 2.

As shown in the example of FIG. 2, computing device 210 includes PSD 212, one or more processors 240, one or more communication units 242, one or more input components 244, one or more output components 246, and one or more storage components 248. Presence-sensitive display 212 includes display component 202 and presence-sensitive input component 204. Storage components 248 of computing device 210 include UI module 220, keyboard module 222, one or more application modules 224, and emoji symbol data store 232. Keyboard module 122 may include spatial model (“SM”) module 226, language model (“LM”) module 228, and search module 230. Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on the one or more networks. Examples of communication units 242 include a network interface card (e.g. such as an Ethernet card), an optical transceiver, a radio frequency transceiver, a GPS receiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 242 of computing device 210, in one example, includes a presence-sensitive input device (e.g., a touch sensitive screen, a PSD), mouse, keyboard, voice responsive system, video camera, microphone or any other type of device for detecting input from a human or machine. In some examples, input components 242 may include one or more sensor components one or more location sensors (GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., microphone, camera, infrared proximity sensor, hygrometer, and the like). Other sensors may include a heart rate sensor, magnetometer, glucose sensor, hygrometer sensor, olfactory sensor, compass sensor, step counter sensor, to name a few other non-limiting examples.

One or more output components 246 of computing device 110 may generate output. Examples of output are tactile, audio, and video output. Output components 246 of computing device 210, in one example, includes a PSD, sound card, video graphics adapter card, speaker, cathode ray tube (CRT) monitor, liquid crystal display (LCD), or any other type of device for generating output to a human or machine.

PSD 212 of computing device 210 is similar to PSD 112 of computing device 110 and includes display component 202 and presence-sensitive input component 204. Display component 202 may be a screen at which information is displayed by PSD 212 and presence-sensitive input component 204 may detect an object at and/or near display component 202. As one example range, presence-sensitive input component 204 may detect an object, such as a finger or stylus that is within two inches or less of display component 202. Presence-sensitive input component 204 may determine a location (e.g., an [x, y] coordinate) of display component 202 at which the object was detected. In another example range, presence-sensitive input component 204 may detect an object six inches or less from display component 202 and other ranges are also possible. Presence-sensitive input component 204 may determine the location of display component 202 selected by a user's finger using capacitive, inductive, and/or optical recognition techniques. In some examples, presence-sensitive input component 204 also provides output to a user using tactile, audio, or video stimuli as described with respect to display component 202. In the example of FIG. 2, PSD 212 may present a user interface (such as graphical user interfaces 114 of FIGS. 1A-1D).

While illustrated as an internal component of computing device 210, PSD 212 may also represent and an external component that shares a data path with computing device 210 for transmitting and/or receiving input and output. For instance, in one example, PSD 212 represents a built-in component of computing device 210 located within and physically connected to the external packaging of computing device 210 (e.g., a screen on a mobile phone). In another example, PSD 212 represents an external component of computing device 210 located outside and physically separated from the packaging or housing of computing device 210 (e.g., a monitor, a projector, etc. that shares a wired and/or wireless data path with computing device 210).

PSD 212 of computing device 210 may detect two-dimensional and/or three-dimensional gestures as input from a user of computing device 210. For instance, a sensor of PSD 212 may detect a user's movement (e.g., moving a hand, an arm, a pen, a stylus, etc.) within a threshold distance of the sensor of PSD 212. PSD 212 may determine a two or three dimensional vector representation of the movement and correlate the vector representation to a gesture input (e.g., a hand-wave, a pinch, a clap, a pen stroke, etc.) that has multiple dimensions. In other words, PSD 212 can detect a multi-dimension gesture without requiring the user to gesture at or near a screen or surface at which PSD 212 outputs information for display. Instead, PSD 212 can detect a multi-dimensional gesture performed at or near a sensor which may or may not be located near the screen or surface at which PSD 212 outputs information for display.

One or more processors 240 may implement functionality and/or execute instructions associated with computing device 210. Examples of processors 240 include application processors, display controllers, auxiliary processors, one or more sensor hubs, and any other hardware configure to function as a processor, a processing unit, or a processing device. Modules 220, 222, 224, 226, 228, and 230 may be operable by processors 240 to perform various actions, operations, or functions of computing device 210. For example, processors 240 of computing device 210 may retrieve and execute instructions stored by storage components 248 that cause processors 240 to perform the operations of modules 220, 222, 224, 226, 228, and 230 and data store 232. The instructions, when executed by processors 240, may cause computing device 210 to store information within storage components 248.

One or more storage components 248 within computing device 210 may store information for processing during operation of computing device 210 (e.g., computing device 210 may store data accessed by modules 220, 222, 224, 226, 228, and 230 and data store 232 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220, 222, 224, 226, 228, and 230 and data store 232. Storage components 248 may include a memory configured to store data or other information associated with modules 220, 222, 224, 226, 228, and 230 and data store 232.

UI module 220 may include all functionality of UI module 120 of computing device 110 of FIGS. 1A-1D and may perform similar operations as UI module 120 for managing a user interface (e.g., user interfaces 114) that computing device 210 provides at presence-sensitive display 212 for handling input from a user. For example, UI module 220 of computing device 210 may query keyboard module 222 for a keyboard layout (e.g., an English language QWERTY keyboard, etc.). UI module 220 may transmit a request for a keyboard layout over communication channels 250 to keyboard module 222. Keyboard module 222 may receive the request and reply to UI module 220 with data associated with the keyboard layout. UI module 220 may receive the keyboard layout data over communication channels 250 and use the data to generate a user interface. UI module 220 may transmit a display command and data over communication channels 250 to cause PSD 212 to present the user interface at PSD 212.

In some examples, UI module 220 may receive an indication of one or more user inputs detected at PSD 212 and may output information about the user inputs to keyboard module 222. For example, PSD 212 may detect a user input and send data about the user input to UI module 220. UI module 220 may generate one or more touch events based on the detected input. A touch event may include information that characterizes user input, such as a location component (e.g., [x,y] coordinates) of the user input, a time component (e.g., when the user input was received), a force component (e.g., an amount of pressure applied by the user input), or other data (e.g., speed, acceleration, direction, density, etc.) about the user input.

Based on location information of the touch events generated from the user input, UI module 220 may determine that the detected user input is associated the graphical keyboard. UI module 220 may send an indication of the one or more touch events to keyboard module 222 for further interpretation. Keyboard module 22 may determine, based on the touch events received from UI module 220, that the detected user input represents an initial selection of one or more keys of the graphical keyboard.

Application modules 224 represent all the various individual applications and services executing at and accessible from computing device 210 that may rely on a graphical keyboard having integrated search features. A user of computing device 210 may interact with a graphical user interface associated with one or more application modules 224 to cause computing device 210 to perform a function. Numerous examples of application modules 224 may exist and include, a fitness application, a calendar application, a personal assistant or prediction engine, a search application, a map or navigation application, a transportation service application (e.g., a bus or train tracking application), a social media application, a game application, an e-mail application, a chat or messaging application, an Internet browser application, or any and all other applications that may execute at computing device 210.

Keyboard module 222 may include all functionality of keyboard module 122 of computing device 110 of FIGS. 1A-1D and may perform similar operations as keyboard module 122 for providing a graphical keyboard having integrated search features, such as emoji search. Keyboard module 222 may include various submodules, such as SM module 226, LM module 228, and search module 230, which may perform the functionality of keyboard module 222.

SM module 226 may receive one or more touch events as input, and output a character or sequence of characters that likely represents the one or more touch events, along with a degree of certainty or spatial model score indicative of how likely or with what accuracy the one or more characters define the touch events. In other words, SM module 226 may infer touch events as a selection of one or more keys of a keyboard and may output, based on the selection of the one or more keys, a character or sequence of characters.

When keyboard module 222 operates in text-entry mode and/or search mode, LM module 228 may receive a character or sequence of characters as input, and output one or more candidate characters, words, or phrases that LM module 228 identifies from a lexicon as being potential replacements for a sequence of characters that LM module 228 receives as input for a given language context (e.g., a sentence in a written language). Keyboard module 222 may cause UI module 220 to present one or more of the candidate words at suggestion regions 118C of user interfaces 114.

The lexicon of computing device 210 may include a list of words within a written language vocabulary (e.g., a dictionary). For instance, the lexicon may include a database of words (e.g., words in a standard dictionary and/or words added to a dictionary by a user or computing device 210. LM module 228 may perform a lookup in the lexicon, of a character string, to identify one or more letters, words, and/or phrases that include parts or all of the characters of the character string. For example, LM module 228 may assign a language model probability or a similarity coefficient (e.g., a Jaccard similarity coefficient) to one or more candidate words located at a lexicon of computing device 210 that include at least some of the same characters as the inputted character or sequence of characters. The language model probability assigned to each of the one or more candidate words indicates a degree of certainty or a degree of likelihood that the candidate word is typically found positioned subsequent to, prior to, and/or within, a sequence of words (e.g., a sentence) generated from text input detected by presence-sensitive input component 204 prior to and/or subsequent to receiving the current sequence of characters being analyzed by LM module 228. In response to determining the one or more candidate words, LM module 228 may output the one or more candidate words from lexicon data stores 260A that have the highest similarity coefficients.

Search module 230 of keyboard module 222 may perform integrated search functions on behalf of keyboard module 222 including emoji search. That is, when invoked (e.g., in response to a user of computing device 210 selecting emoji search key 118D of user interface 114A), keyboard module 222 may operate in search mode where keyboard module 222 enables computing device 210 to perform an emoji search functions from within graphical keyboard 116B.

Emoji symbol data store 232 represents an on-device (e.g., locally stored at storage device 248) emoji symbol database that stores emoji symbols. Search module 230 may query data store 232 against an emoji search query to obtain on or more candidate emoji symbols. For example, data store 232 may be a sqlite3 or other type of database with indications of emoji symbols and associated annotations for parsing a search query for keywords and matching the keywords of the search query to words or phrases that have been pre-assigned to emoji symbols within the database. As the user inputs an emoji search query, search module 230 may input the emoji search query predictions into data store 232 so as to execute a full search of the predicted search query against the emoji symbol descriptors within the database.

It may be important, as part of a user experience in interacting with graphical keyboard 116B, that emoji search be as fast as possible, if not as fast, or almost as fast, as typical text-entry operations. To ensure emoji search executes as fast as possible, search module 230 may execute at computing device 110 without accessing any remote computing devices. While search module 230 may in some examples access a remote emoji symbol data base as part of an emoji search operation, search module 230 may primarily access emoji symbol data store 232 for conducting an emoji search. Search module 230 may access data store 232, which is stored local to computing device 210 at storage devices 248, faster than having to access a remote database, thus enabling search module 230 to conduct emoji searches in a lesser amount of time.

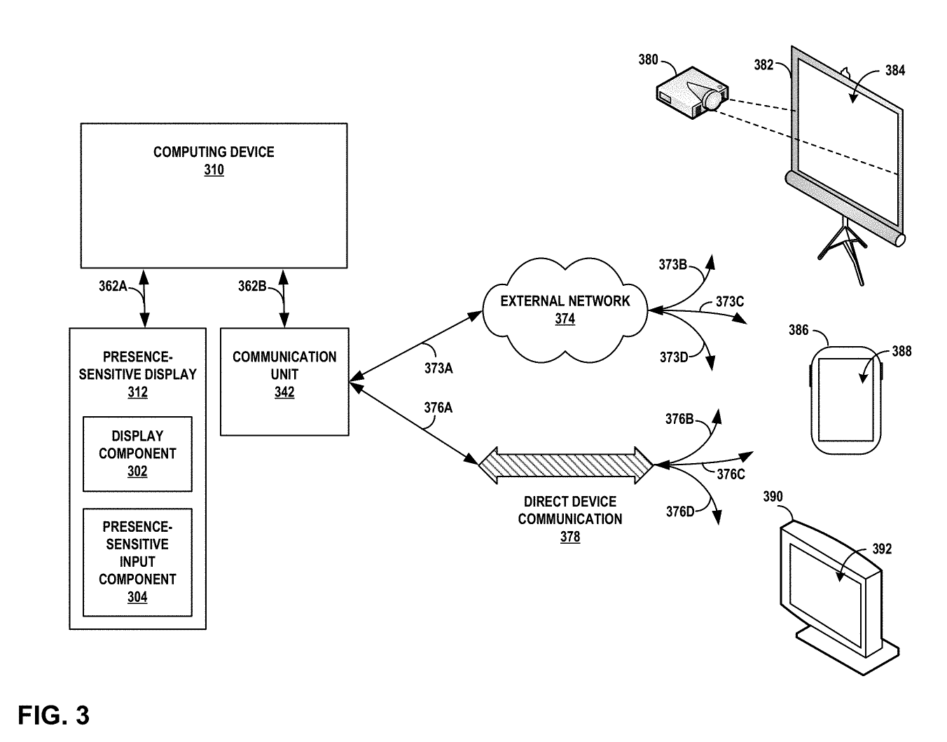

FIG. 3 is a block diagram illustrating an example computing device that outputs graphical content for display at a remote device, in accordance with one or more techniques of the present disclosure. Graphical content, generally, may include any visual information that may be output for display, such as text, images, a group of moving images, to name only a few examples. The example shown in FIG. 3 includes a computing device 310, a PSD 312, communication unit 342, projector 380, projector screen 382, mobile device 386, and visual display component 390. In some examples, PSD 312 may be a presence-sensitive display as described in FIGS. 1-2. Although shown for purposes of example in FIGS. 1 and 2 as a stand-alone computing device 110, a computing device such as computing device 310 may, generally, be any component or system that includes a processor or other suitable computing environment for executing software instructions and, for example, need not include a presence-sensitive display.

As shown in the example of FIG. 3, computing device 310 may be a processor that includes functionality as described with respect to processors 240 in FIG. 2. In such examples, computing device 310 may be operatively coupled to PSD 312 by a communication channel 362A, which may be a system bus or other suitable connection. Computing device 310 may also be operatively coupled to communication unit 342, further described below, by a communication channel 362B, which may also be a system bus or other suitable connection. Although shown separately as an example in FIG. 3, computing device 310 may be operatively coupled to PSD 312 and communication unit 342 by any number of one or more communication channels.

In other examples, such as illustrated previously by computing device 110 in FIGS. 1-2, a computing device may refer to a portable or mobile device such as mobile phones (including smart phones), laptop computers, etc. In some examples, a computing device may be a desktop computer, tablet computer, smart television platform, camera, personal digital assistant (PDA), server, or mainframes.

PSD 312 may include display component 302 and presence-sensitive input component 304. Display component 302 may, for example, receive data from computing device 310 and display the graphical content. In some examples, presence-sensitive input component 304 may determine one or more user inputs (e.g., continuous gestures, multi-touch gestures, single-touch gestures) at PSD 312 using capacitive, inductive, and/or optical recognition techniques and send indications of such user input to computing device 310 using communication channel 362A. In some examples, presence-sensitive input component 304 may be physically positioned on top of display component 302 such that, when a user positions an input unit over a graphical element displayed by display component 302, the location at which presence-sensitive input component 304 corresponds to the location of display component 302 at which the graphical element is displayed.

As shown in FIG. 3, computing device 310 may also include and/or be operatively coupled with communication unit 342. Communication unit 342 may include functionality of communication unit 242 as described in FIG. 2. Examples of communication unit 342 may include a network interface card, an Ethernet card, an optical transceiver, a radio frequency transceiver, or any other type of device that can send and receive information. Other examples of such communication units may include Bluetooth, 3G, and WiFi radios, Universal Serial Bus (USB) interfaces, etc. Computing device 310 may also include and/or be operatively coupled with one or more other devices (e.g., input devices, output components, memory, storage devices) that are not shown in FIG. 3 for purposes of brevity and illustration.

FIG. 3 also illustrates a projector 380 and projector screen 382. Other such examples of projection devices may include electronic whiteboards, holographic display components, and any other suitable devices for displaying graphical content. Projector 380 and projector screen 382 may include one or more communication units that enable the respective devices to communicate with computing device 310. In some examples, the one or more communication units may enable communication between projector 380 and projector screen 382. Projector 380 may receive data from computing device 310 that includes graphical content. Projector 380, in response to receiving the data, may project the graphical content onto projector screen 382. In some examples, projector 380 may determine one or more user inputs (e.g., continuous gestures, multi-touch gestures, single-touch gestures) at projector screen using optical recognition or other suitable techniques and send indications of such user input using one or more communication units to computing device 310. In such examples, projector screen 382 may be unnecessary, and projector 380 may project graphical content on any suitable medium and detect one or more user inputs using optical recognition or other such suitable techniques.

Projector screen 382, in some examples, may include a presence-sensitive display 384. Presence-sensitive display 384 may include a subset of functionality or all of the functionality of presence-sensitive display 112 and/or 312 as described in this disclosure. In some examples, presence-sensitive display 384 may include additional functionality. Projector screen 382 (e.g., an electronic whiteboard), may receive data from computing device 310 and display the graphical content. In some examples, presence-sensitive display 384 may determine one or more user inputs (e.g., continuous gestures, multi-touch gestures, single-touch gestures) at projector screen 382 using capacitive, inductive, and/or optical recognition techniques and send indications of such user input using one or more communication units to computing device 310.

FIG. 3 also illustrates mobile device 386 and visual display component 390. Mobile device 386 and visual display component 390 may each include computing and connectivity capabilities. Examples of mobile device 386 may include e-reader devices, convertible notebook devices, hybrid slate devices, etc. Examples of visual display component 390 may include other devices such as televisions, computer monitors, etc. In some examples, visual display component 390 may be a vehicle cockpit display or navigation display (e.g., in an automobile, aircraft, or some other vehicle). In some examples, visual display component 390 may be a home automation display or some other type of display that is separate from computing device 310.

As shown in FIG. 3, mobile device 386 may include a presence-sensitive display 388. Visual display component 390 may include a presence-sensitive display 392. Presence-sensitive displays 388, 392 may include a subset of functionality or all of the functionality of presence-sensitive display 112, 212, and/or 312 as described in this disclosure. In some examples, presence-sensitive displays 388, 392 may include additional functionality. In any case, presence-sensitive display 392, for example, may receive data from computing device 310 and display the graphical content. In some examples, presence-sensitive display 392 may determine one or more user inputs (e.g., continuous gestures, multi-touch gestures, single-touch gestures) at projector screen using capacitive, inductive, and/or optical recognition techniques and send indications of such user input using one or more communication units to computing device 310.

As described above, in some examples, computing device 310 may output graphical content for display at PSD 312 that is coupled to computing device 310 by a system bus or other suitable communication channel. Computing device 310 may also output graphical content for display at one or more remote devices, such as projector 380, projector screen 382, mobile device 386, and visual display component 390. For instance, computing device 310 may execute one or more instructions to generate and/or modify graphical content in accordance with techniques of the present disclosure. Computing device 310 may output the data that includes the graphical content to a communication unit of computing device 310, such as communication unit 342. Communication unit 342 may send the data to one or more of the remote devices, such as projector 380, projector screen 382, mobile device 386, and/or visual display component 390. In this way, computing device 310 may output the graphical content for display at one or more of the remote devices. In some examples, one or more of the remote devices may output the graphical content at a presence-sensitive display that is included in and/or operatively coupled to the respective remote devices.

In some examples, computing device 310 may not output graphical content at PSD 312 that is operatively coupled to computing device 310. In other examples, computing device 310 may output graphical content for display at both a PSD 312 that is coupled to computing device 310 by communication channel 362A, and at one or more remote devices. In such examples, the graphical content may be displayed substantially contemporaneously at each respective device. For instance, some delay may be introduced by the communication latency to send the data that includes the graphical content to the remote device. In some examples, graphical content generated by computing device 310 and output for display at PSD 312 may be different than graphical content display output for display at one or more remote devices.

Computing device 310 may send and receive data using any suitable communication techniques. For example, computing device 310 may be operatively coupled to external network 374 using network link 373A. Each of the remote devices illustrated in FIG. 3 may be operatively coupled to network external network 374 by one of respective network links 373B, 373C, or 373D. External network 374 may include network hubs, network switches, network routers, etc., that are operatively inter-coupled thereby providing for the exchange of information between computing device 310 and the remote devices illustrated in FIG. 3. In some examples, network links 373A-373D may be Ethernet, ATM or other network connections. Such connections may be wireless and/or wired connections.

In some examples, computing device 310 may be operatively coupled to one or more of the remote devices included in FIG. 3 using direct device communication 378. Direct device communication 378 may include communications through which computing device 310 sends and receives data directly with a remote device, using wired or wireless communication. That is, in some examples of direct device communication 378, data sent by computing device 310 may not be forwarded by one or more additional devices before being received at the remote device, and vice-versa. Examples of direct device communication 378 may include Bluetooth, Near-Field Communication, Universal Serial Bus, WiFi, infrared, etc. One or more of the remote devices illustrated in FIG. 3 may be operatively coupled with computing device 310 by communication links 376A-376D. In some examples, communication links 376A-376D may be connections using Bluetooth, Near-Field Communication, Universal Serial Bus, infrared, etc. Such connections may be wireless and/or wired connections.

In accordance with techniques of the disclosure, computing device 310 may be operatively coupled to visual display component 390 using external network 374. Computing device 310 may output a graphical keyboard that includes an emoji search box for display at PSD 392. For instance, computing device 310 may send data that includes a representation of the graphical keyboard with an emoji search box to communication unit 342. Communication unit 342 may send the data that includes the representation of the graphical keyboard with an emoji search box to visual display component 390 using external network 374. Visual display component 390, in response to receiving the data using external network 374, may cause PSD 392 to output the graphical keyboard with an emoji search box. In response to receiving a user input at PSD 392 to input an emoji search query within the emoji search box, visual display device 130 may send an indication of the user input to computing device 310 using external network 374. Communication unit 342 of may receive the indication of the user input, and send the indication to computing device 310.

Computing device 310 may determine, based on the user input, an emoji search query. For example, computing device 310 may determine, based on the user input, a selection of one or more keys for entering one or more candidate words that make up a query. Computing device 310 may identify, using an emoji search function, one or more candidate emoji symbols from a searchable emoji symbol database stored local to computing device 310 that match the query.

Responsive to obtaining one or more candidate emoji symbols that match the query, computing device 310 may output a representation of an updated graphical user interface including an updated graphical keyboard that includes an emoji suggestion region having graphical indications of the one or more candidate emoji symbols. Communication unit 342 may receive the representation of the updated graphical user interface and may send the send the representation to visual display component 390, such that visual display component 390 may cause PSD 392 to output the updated graphical keyboard, including the emoji suggestion region.

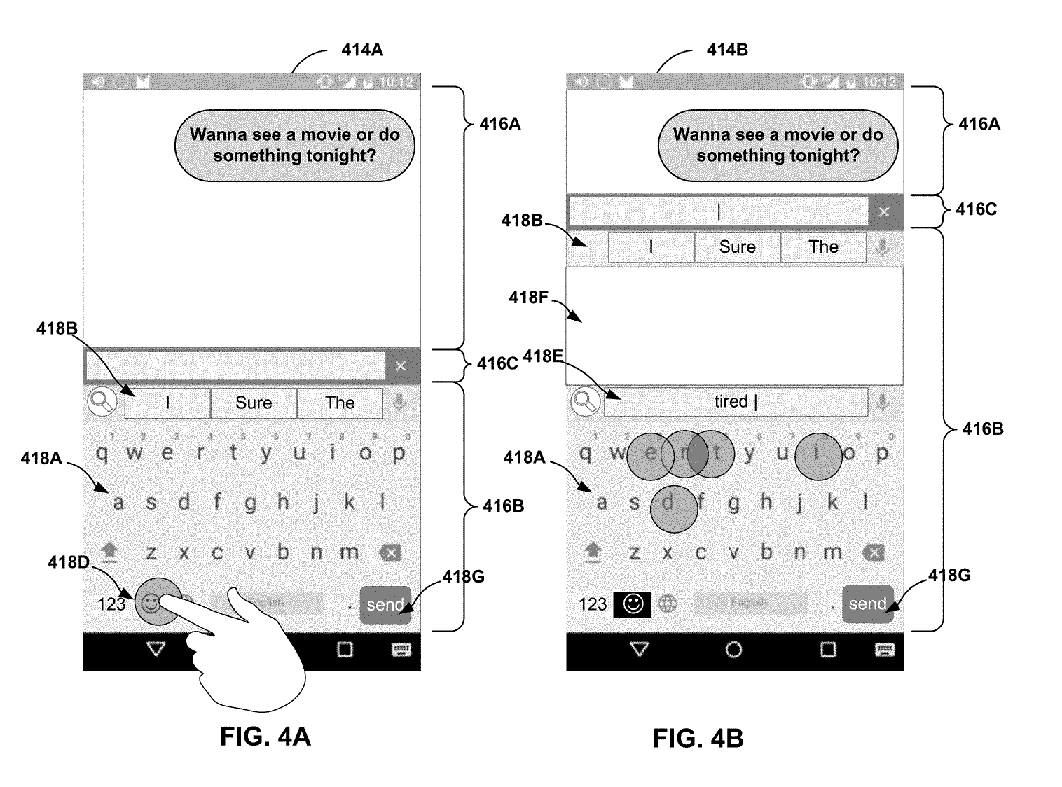

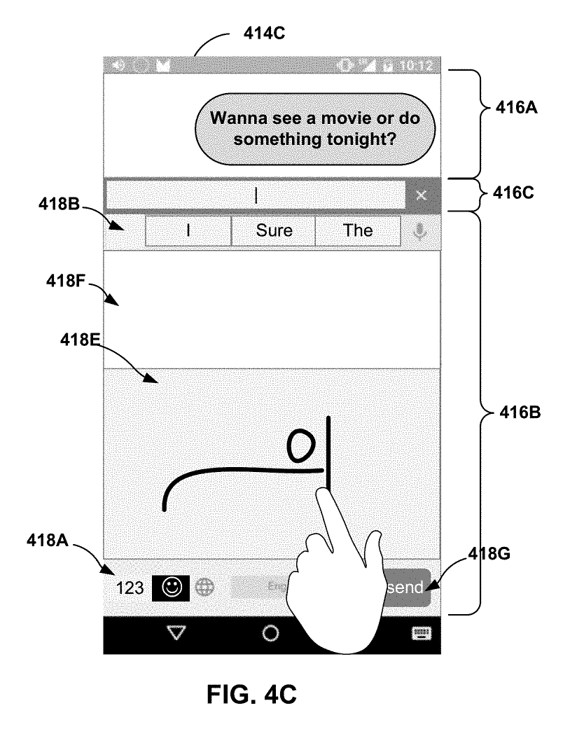

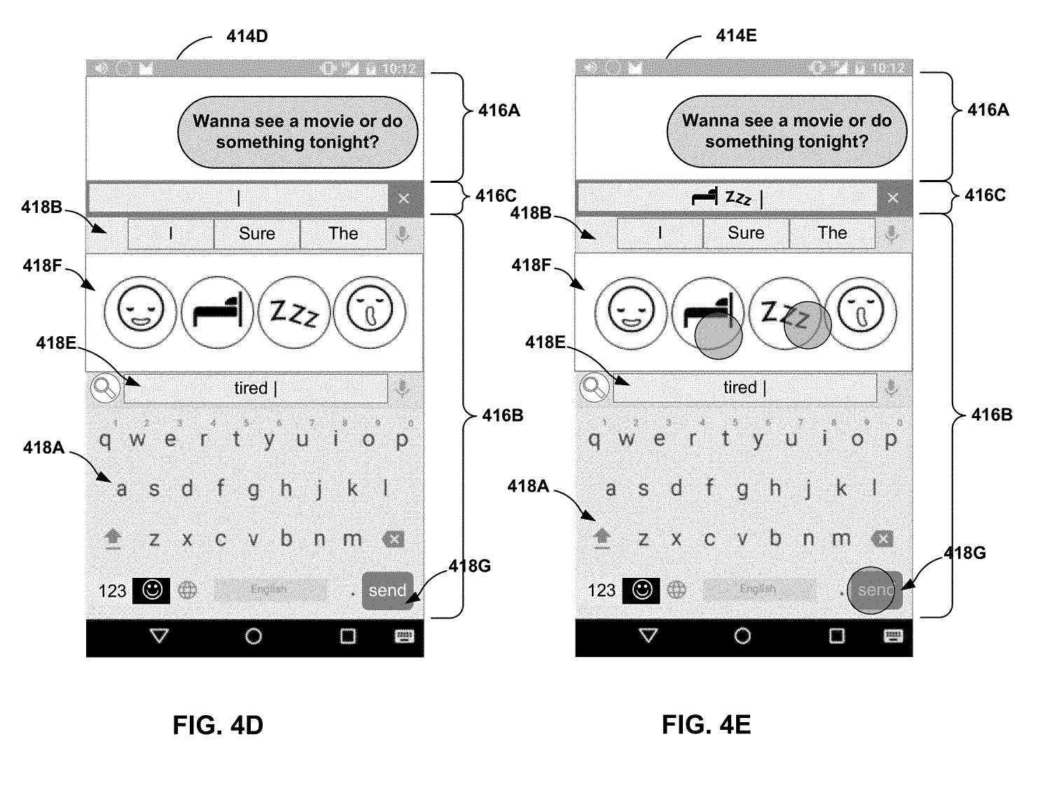

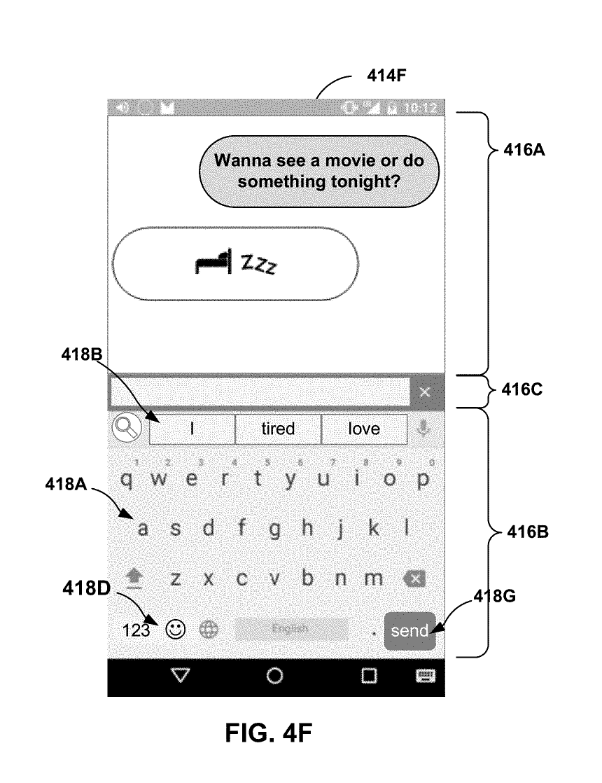

FIGS. 4A-4F are conceptual diagrams illustrating example graphical user interfaces of an example computing device that is configured to present a graphical keyboard with integrated iconographic search, in accordance with one or more aspects of the present disclosure. FIGS. 4A-4F illustrate, respectively, example graphical user interfaces 414A-414F (collectively, user interfaces 414). However, many other examples of graphical user interfaces may be used in other instances. Each of graphical user interfaces 414 may correspond to a graphical user interface displayed by computing devices 110 or 210 of FIGS. 1 and 2 respectively. FIGS. 4A-4E are described below in the context of computing device 110.

Each of user interfaces 414 includes output region 416A, edit region 416C, and graphical keyboard 416B, and within graphical keyboard 416B each of user interfaces 414 includes edit region 418B and at least a portion of graphical keys 418A, including emoji search key 418D and a message send key 418G. User interfaces 414B-414E each includes an example of emoji search box 418E and emoji suggestion region 418F. As shown in FIGS. 4A-4F, computing device 110 may continuously display edit region 416C of user interfaces 414 while at least one of graphical keyboard 416B is output for display, and each of the updated user interfaces 414B-414E including emoji search box 418E and emoji suggestion region 418F are output for display.

As shown in FIG. 4A, computing device 110 may receive a text message from a different computing device associated with a friend of a user and the user may wish to reply using an iconographic symbol such as an emoticon. Computing device may detect user input at a location at which PSD 112 presents emoji search key 418D.

As shown in FIG. 4B, after computing device 110 receives an indication of a selection of emoji search key 418D, keyboard module 122 may transition to operating in emoji search mode and may cause UI module 120 to increase a size of graphical keyboard 416B being presented at PSD 112 to accommodate emoji search box 418E and emoji suggestion region 418F. For example, FIG. 4B shows computing device 110 presenting graphical keyboard 116B in a vertical orientation and having an increased vertical size to accommodate emoji search box 418E and emoji suggestion region 418F as compared to a vertical size of graphical keyboard 116B shown in FIG. 4A. In other examples (e.g., in a landscape orientation) computing device 110 may alter a width or other size parameter of graphical keyboard 116B to accommodate emoji search box 418E and emoji suggestion region 418F. For instance, computing device 110 may shrink a size of graphical keys 118A to accommodate emoji search box 418E and emoji suggestion region 418F while the overall vertical or horizontal size of graphical keyboard 116 remains the same regardless whether emoji search box 418E and emoji suggestion region 418F are displayed.

As shown in FIG. 4B, emoji search box 418E is configured to receive text input. The user of computing device 110 may provide tap inputs at or near the locations of various keys 418A to type the emoji search query “tired”. In response to the tap inputs at keys 418A, keyboard module 122 may receive an indication of the tap inputs and determine, based on the tap inputs, text input as one or more candidate words that begin or include the characters “tired”. Keyboard module 122 may use the candidate words as emoji search queries. As a form of feedback to the user, keyboard module 122 may cause UI module 120 to present a graphical indication of the emoji search query “tired” within emoji search box 418E.

In other example, the user of computing device 110 may tap at the microphone icon presented adjacent to emoji search box 118E to configure computing device 110 to receive voice-input. After pressing the microphone icon, computing device 110 may receive voice input from a user as the user dictates an emoji search query. Computing device 110 may transcribe the voice input to text and process the text input into an emoji search query in a similar way in which computing device 110 processes typing input into an emoji search query.

FIG. 4C shows an alternative way a user may input an emoji search query as compared to FIG. 4B. As shown in FIG. 4C, emoji search box 418E is configured to receive hand drawn input (e.g., based on a user drawing with a finger, hand, or stylus at or near PSD 112). The user of computing device 110 may provide touch inputs at or near the location of emoji search box 118E to draw, rather than type, a picture resembling the particular emoji symbol that the user is searching for. For example, rather than type the word tired, the user may draw an iconographic symbol that resembles a bed. In response to the hand drawn input detected at emoji search box 118E, keyboard module 122 may receive an indication of the hand drawn input and determine, based on the hand drawn input one or more matching iconographic symbols that appear similar to the hand drawn input. As a form of feedback to the user, keyboard module 122 may cause UI module 120 to present a graphical indication of the hand drawn input within emoji search box 418E. In other examples, a user may provide hand drawn input as a way to input characters (e.g., letters, words, etc.) and using similar techniques to those described with respect to FIG. 4B, determine one or more candidate emoji symbols based on the hand drawn input.

In any case, as shown in FIG. 4D, no matter the form of user input, keyboard module 122 computing device 110 may execute an iconographic search based on the search query determined from the user input. Keyboard module 122 may cause UI module 120 to present at PSD 112, one or more selectable, graphical indications of the one or more candidate emoji symbols that keyboard module 122 determines based on the search. For example, in response to determining the search query to be “tired” or a drawing of a bed, keyboard module 122 may identify a tired face emoji, a bed emoji, a sleeping “Zzz” emoji, and a yawning face emoji as all example iconographic symbols that are related to the word “tired” or the drawing of a bed.

Next, as shown in FIG. 4E, computing device 110 may determine that a user has provided touch input at or near locations at which UI module 120 causes PSD 112 to present the bed emoji and the sleeping “Zzz” emoji. Keyboard module 122 may determine that the user has selected the bed emoji and the sleeping “Zzz” emoji for inclusion into an electronic message. Responsive to detecting the user input to select the bed emoji and the sleeping “Zzz” emoji, keyboard module 122 may cause UI module 120 to include the selected emoji symbols within edit region 116C.

Finally, as shown in FIG. 4F, after pressing send key 118G, computing device 110 may send an electronic message to the different computing device associated with the friend that includes data indicative of the bed emoji and the sleeping “Zzz” emoji. Computing device 110 may cause UI module 120 to present the body of the electronic message within output region 116A.

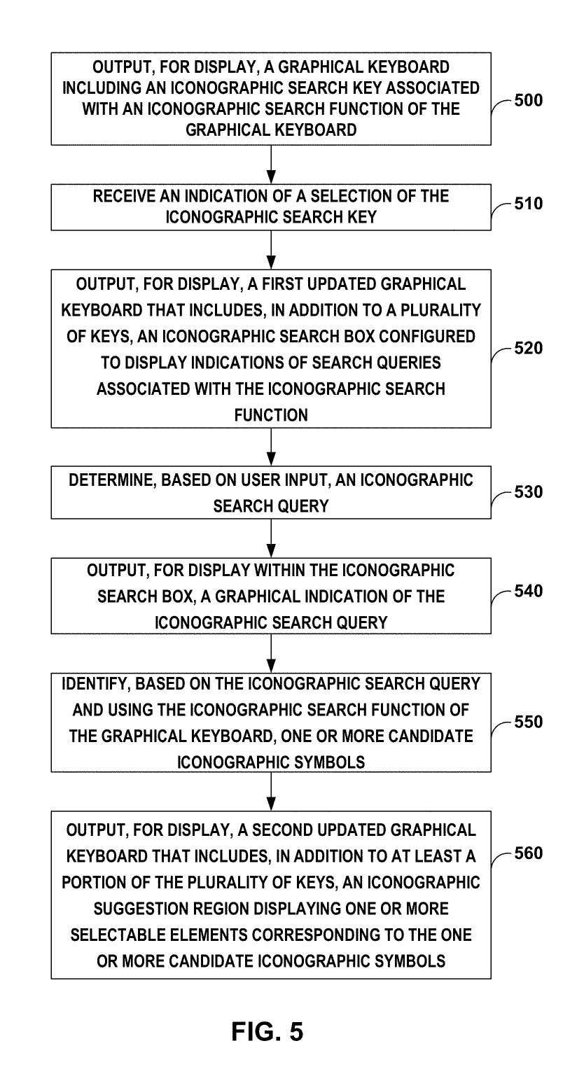

FIG. 5 is a flowchart illustrating example operations of a computing device that is configured to present a graphical keyboard with integrated iconographic search, in accordance with one or more aspects of the present disclosure. The operations of FIG. 5 may be performed by one or more processors of a computing device, such as computing devices 110 of FIG. 1 or computing device 210 of FIG. 2. For purposes of illustration only, FIG. 5 is described below within the context of computing devices 110 of FIGS. 1A-1D.

In operation, computing device 110 may output, for display, a graphical keyboard comprising a plurality of keys, wherein the plurality of keys includes an iconographic search key associated with an iconographic search function of the graphical keyboard (500). For example, keyboard module 122 may cause UI module 120 to present user interface 114A at PSD 112 including emoji search key 118D.

Computing device 110 may receive an indication of a selection of the iconographic search key (510). For example, a user may provide input detected at a location of PSD 112 at which emoji search key 118D is displayed. Keyboard module 122 may receive information from UI module 120 about the detected input and transition to search mode for performing an emoji search.

Responsive to receiving an indication of a selection of the iconographic search key, computing device 110 may output, for display, a first updated graphical keyboard that includes, in addition to the plurality of keys, an iconographic search box configured to display indications of search queries associated with the iconographic search function (520). For example, responsive to transitioning to emoji search, keyboard module 122 may cause UI module 120 to present user interface 114B at PSD 112 including emoji suggestion region 118E.

Computing device 110 may determine, based on user input, an iconographic search query (530). For example, as the user provides touch input at locations of PSD 112 at which graphical keys 118A are displayed, keyboard module 122 may predict an emoji search query that the user may be typing. For example, if the user types “ca”, keyboard module 122 may determine cat, caterpillar, camels, chatting, etc. as all possible emoji search queries.

Computing device 110 may output, for display within the iconographic search box, a graphical indication of the iconographic search query (540). For example, as keyboard module 122 determines one or more emoji search queries based on the user input, keyboard module 122 may cause UI module 120 to present the text descriptors of the predicted queries within emoji search box 118E.

Computing device 110 may identify, based on the iconographic search query and using the iconographic search function of the graphical keyboard, one or more candidate iconographic symbols (550). For example, as keyboard module 122 determines one or more emoji search queries based on the user input, keyboard module 122 may simultaneously query a database of emoji symbols for the predicted search queries.

Responsive to identifying the one or more candidate iconographic symbols, computing device 110 may output, for display, a second updated graphical keyboard that includes, in addition to at least a portion of the plurality of keys, an iconographic suggestion region displaying one or more selectable elements corresponding to the one or more candidate iconographic symbols (560). For example, as keyboard module 122 identifies matching emoji symbols from the data base, keyboard module 122 may cause UI module 120 to present user interface 114C including graphical indications of the emoji symbols that match the predicted queries within emoji suggestion region 118F.

The following numbered clauses may illustrate one or more aspects of the disclosure:

Clause 1. A method comprising: outputting, by a computing device, for display, a graphical keyboard comprising a plurality of keys, wherein the plurality of keys includes an iconographic search key associated with an iconographic search function of the graphical keyboard; responsive to receiving an indication of a selection of the iconographic search key, outputting, by the computing device, for display, a first updated graphical keyboard that includes, in addition to the plurality of keys, an iconographic search box configured to display indications of search queries associated with the iconographic search function; determining, by the computing device, based on user input, an iconographic search query; outputting, by the computing device, for display within the iconographic search box, a graphical indication of the iconographic search query; identifying, by the computing device, based on the iconographic search query and using the iconographic search function of the graphical keyboard, one or more candidate iconographic symbols; and responsive to identifying the one or more candidate iconographic symbols, outputting, by the computing device, for display, a second updated graphical keyboard that includes, in addition to at least a portion of the plurality of keys, an iconographic suggestion region displaying one or more selectable elements corresponding to the one or more candidate iconographic symbols.

Clause 2. The method of clause 1, wherein the graphical keyboard, the first updated graphical keyboard, and the second updated graphical keyboard are output for display as part of an application graphical user interface.

Clause 3. The method of clause 2, wherein the application graphical user interface includes an edit region, the method further comprising responsive to receiving an indication of a selection of at least one of the one or more selectable elements, outputting, by the computing device, for display, within the edit region, at least one of the one or more candidate iconographic symbols.

Clause 4. The method of any of clauses 2-3, further comprising: continuously displaying, by the computing device, the edit region of the application graphical user interface while at least one of: the graphical keyboard is output for display; the first updated graphical keyboard is output for display; or the second updated graphical keyboard is output for display.

Clause 5. The method of clause 4, wherein a size of the first updated graphical keyboard is greater than a size of the graphical keyboard to accommodate the iconographic search box.

Clause 6. The method of any of clauses 1-5, wherein the at least a portion of the plurality of keys includes a return key or a message send key.

Clause 7. The method of any of clauses 1-6, the method further comprising: determining, by the computing device, based on the user input, text input, wherein: the iconographic search query is determined based on the text input; and the graphical indication of the iconographic search query is a graphical indication of the text input.

Clause 8. The method of clause 7, wherein the user input is a selection of one or more textual character keys of the plurality of keys or a voice input.

Clause 9. The method of any of clauses 1-6, wherein: the user input is hand drawn input, the iconographic search query is determined based on the hand drawn input, and the graphical indication of the iconographic search query is a graphical indication of the hand drawn input.

Clause 10. The method of clause 9, wherein the hand drawn input corresponds to a user drawing of an iconographic symbol or handwritten input of text associated with the iconographic search query.

Clause 11. The method of any of clauses 1-10, wherein: the iconographic search key is an emoji search key; the iconographic search function is an emoji search function; the iconographic search box is an emoji search box; the iconographic search query is an emoji search query; the iconographic suggestion region is an emoji suggestion region; and the one or more candidate iconographic symbols include one or more candidate emoji symbols.

Clause 12. A computing device comprising: a presence-sensitive display; at least one processor; and a memory that stores instructions that, when executed by the at least one processor, cause the at least one processor to: output, for display at the presence-sensitive display, a graphical keyboard comprising a plurality of keys, wherein the plurality of keys includes an iconographic search key associated with an iconographic search function of the graphical keyboard; responsive to receiving an indication of a selection of the iconographic search key detected at the presence-sensitive display, output, for display at the presence-sensitive display, a first updated graphical keyboard that includes, in addition to the plurality of keys, an iconographic search box configured to display indications of search queries associated with the iconographic search function; determine, based on user input, an iconographic search query; output, for display at the presence-sensitive display, within the iconographic search box, a graphical indication of the iconographic search query; identify, based on the iconographic search query and using the iconographic search function of the graphical keyboard, one or more candidate iconographic symbols; and responsive to identifying the one or more candidate iconographic symbols, output, for display at the presence-sensitive display, a second updated graphical keyboard that includes, in addition to at least a portion of the plurality of keys, an iconographic suggestion region displaying one or more selectable elements corresponding to the one or more candidate iconographic symbols.

Clause 13. The computing device of clause 12, wherein the instructions, when executed, cause the at least one processor to output, for display, as part of an application graphical user interface, the graphical keyboard, the first updated graphical keyboard, and the second updated graphical keyboard.

Clause 14. The computing device of clause 13, wherein the application graphical user interface includes an edit region, and wherein the instructions, when executed, further cause the at least one processor to responsive to receiving an indication of a selection of at least one of the one or more selectable elements, output, for display, within the edit region, at least one of the one or more candidate iconographic symbols.

Clause 15. The computing device of any of clauses 13-14, wherein the instructions, when executed, cause the at least one processor to continuously display the edit region of the application graphical user interface while at least one of: the graphical keyboard is output for display; the first updated graphical keyboard is output for display; or the second updated graphical keyboard is output for display.

Clause 16. The computing device of clause 15, wherein a size of the first updated graphical keyboard is greater than a size of the graphical keyboard.

Clause 17. The computing device of clause 16, wherein a size of the second updated graphical keyboard is greater than the size of the first updated graphical keyboard.

Clause 18. A computer-readable storage medium encoded with instructions that, when executed by at least one processor of a computing device, cause the at least one processor to: output, for display, a graphical keyboard comprising a plurality of keys, wherein the plurality of keys includes an iconographic search key associated with an iconographic search function of the graphical keyboard; responsive to receiving an indication of a selection of the iconographic search key, output, for display, a first updated graphical keyboard that includes, in addition to the plurality of keys, an iconographic search box configured to display indications of search queries associated with the iconographic search function; determine, based on user input, an iconographic search query; output, for display within the iconographic search box, a graphical indication of the iconographic search query; identify, based on the iconographic search query and using the iconographic search function of the graphical keyboard, one or more candidate iconographic symbols; and responsive to identifying the one or more candidate iconographic symbols, output, for display, a second updated graphical keyboard that includes, in addition to at least a portion of the plurality of keys, an iconographic suggestion region displaying one or more selectable elements corresponding to the one or more candidate iconographic symbols.

Clause 19. The computer-readable storage medium of clause 18, wherein the instructions, when executed, further cause the at least one processor to output, for display, as part of an application graphical user interface, the graphical keyboard, the first updated graphical keyboard, and the second updated graphical keyboard.

Clause 20. The computer-readable storage medium of clause 19, wherein the application graphical user interface includes an edit region, and wherein the instructions, when executed, further cause the at least one processor to responsive to receiving an indication of a selection of at least one of the one or more selectable elements, output, for display, within the edit region, at least one of the one or more candidate iconographic symbols.

Clause 21. A system comprising means for performing any of the methods of clauses 1-11.

Clause 22. A computing device comprising means for performing any of the methods of clauses 1-11.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A method comprising:
outputting, by a computing device, for display, a graphical keyboard comprising a plurality of keys, wherein the plurality of keys includes an iconographic search key associated with an iconographic search function of the graphical keyboard;
responsive to receiving an indication of a selection of the iconographic search key, outputting, by the computing device, for display, a first updated graphical keyboard that includes, in addition to the plurality of keys, an iconographic search box configured to display indications of search queries associated with the iconographic search function;
determining, by the computing device, based on user input, an iconographic search query;
outputting, by the computing device, for display within the iconographic search box, a graphical indication of the iconographic search query;
identifying, by the computing device, based on the iconographic search query and using the iconographic search function of the graphical keyboard, one or more candidate iconographic symbols; and
responsive to identifying the one or more candidate iconographic symbols, outputting, by the computing device, for display, a second updated graphical keyboard that includes, in addition to at least a portion of the plurality of keys, an iconographic suggestion region displaying one or more selectable elements corresponding to the one or more candidate iconographic symbols.

2. The method of claim 1, wherein the graphical keyboard, the first updated graphical keyboard, and the second updated graphical keyboard are output for display as part of an application graphical user interface.

3. The method of claim 2, wherein the application graphical user interface includes an edit region, the method further comprising responsive to receiving an indication of a selection of at least one of the one or more selectable elements, outputting, by the computing device, for display, within the edit region, at least one of the one or more candidate iconographic symbols.

4. The method of claim 2, further comprising:
continuously displaying, by the computing device, the edit region of the application graphical user interface while at least one of:
the graphical keyboard is output for display;
the first updated graphical keyboard is output for display; or
the second updated graphical keyboard is output for display.

5. The method of claim 4, wherein a size of the first updated graphical keyboard is greater than a size of the graphical keyboard to accommodate the iconographic search box.

6. The method of claim 1, wherein the at least a portion of the plurality of keys includes a return key or a message send key.

7. The method of claim 1, the method further comprising:
determining, by the computing device, based on the user input, text input, wherein:
the iconographic search query is determined based on the text input; and
the graphical indication of the iconographic search query is a graphical indication of the text input.

8. The method of claim 7, wherein the user input is a selection of one or more textual character keys of the plurality of keys or a voice input.

9. The method of claim 1, wherein:
the user input is hand drawn input,
the iconographic search query is determined based on the hand drawn input, and
the graphical indication of the iconographic search query is a graphical indication of the hand drawn input.

10. The method of claim 9, wherein the hand drawn input corresponds to a user drawing of an iconographic symbol or handwritten input of text associated with the iconographic search query.

11. The method of claim 1, wherein:
the iconographic search key is an emoji search key;
the iconographic search function is an emoji search function;
the iconographic search box is an emoji search box;
the iconographic search query is an emoji search query;
the iconographic suggestion region is an emoji suggestion region; and
the one or more candidate iconographic symbols include one or more candidate emoji symbols.

12. A computing device comprising:
a presence-sensitive display;
at least one processor; and
a memory that stores instructions that, when executed by the at least one processor, cause the at least one processor to:
output, for display at the presence-sensitive display, a graphical keyboard comprising a plurality of keys, wherein the plurality of keys includes an iconographic search key associated with an iconographic search function of the graphical keyboard;
responsive to receiving an indication of a selection of the iconographic search key detected at the presence-sensitive display, output, for display at the presence-sensitive display, a first updated graphical keyboard that includes, in addition to the plurality of keys, an iconographic search box configured to display indications of search queries associated with the iconographic search function;
determine, based on user input, an iconographic search query;
output, for display at the presence-sensitive display, within the iconographic search box, a graphical indication of the iconographic search query;
identify, based on the iconographic search query and using the iconographic search function of the graphical keyboard, one or more candidate iconographic symbols; and
responsive to identifying the one or more candidate iconographic symbols, output, for display at the presence-sensitive display, a second updated graphical keyboard that includes, in addition to at least a portion of the plurality of keys, an iconographic suggestion region displaying one or more selectable elements corresponding to the one or more candidate iconographic symbols.

13. The computing device of claim 12, wherein the instructions, when executed, cause the at least one processor to output, for display, as part of an application graphical user interface, the graphical keyboard, the first updated graphical keyboard, and the second updated graphical keyboard.

14. The computing device of claim 13, wherein the application graphical user interface includes an edit region, and wherein the instructions, when executed, further cause the at least one processor to responsive to receiving an indication of a selection of at least one of the one or more selectable elements, output, for display, within the edit region, at least one of the one or more candidate iconographic symbols.

15. The computing device of claim 13, wherein the instructions, when executed, cause the at least one processor to
continuously display the edit region of the application graphical user interface while at least one of:
the graphical keyboard is output for display;
the first updated graphical keyboard is output for display; or
the second updated graphical keyboard is output for display.

16. The computing device of claim 15, wherein a size of the first updated graphical keyboard is greater than a size of the graphical keyboard.

17. The computing device of claim 16, wherein a size of the second updated graphical keyboard is greater than the size of the first updated graphical keyboard.

18. A computer-readable storage medium encoded with instructions that, when executed by at least one processor of a computing device, cause the at least one processor to:
output, for display, a graphical keyboard comprising a plurality of keys, wherein the plurality of keys includes an iconographic search key associated with an iconographic search function of the graphical keyboard;
responsive to receiving an indication of a selection of the iconographic search key, output, for display, a first updated graphical keyboard that includes, in addition to the plurality of keys, an iconographic search box configured to display indications of search queries associated with the iconographic search function;
determine, based on user input, an iconographic search query;
output, for display within the iconographic search box, a graphical indication of the iconographic search query;
identify, based on the iconographic search query and using the iconographic search function of the graphical keyboard, one or more candidate iconographic symbols; and
responsive to identifying the one or more candidate iconographic symbols, output, for display, a second updated graphical keyboard that includes, in addition to at least a portion of the plurality of keys, an iconographic suggestion region displaying one or more selectable elements corresponding to the one or more candidate iconographic symbols.

19. The computer-readable storage medium of claim 18, wherein the instructions, when executed, further cause the at least one processor to output, for display, as part of an application graphical user interface, the graphical keyboard, the first updated graphical keyboard, and the second updated graphical keyboard.

20. The computer-readable storage medium of claim 19, wherein the application graphical user interface includes an edit region, and wherein the instructions, when executed, further cause the at least one processor to responsive to receiving an indication of a selection of at least one of the one or more selectable elements, output, for display, within the edit region, at least one of the one or more candidate iconographic symbols.
